(19) United States
(12) Patent Application Publication
(10) Pub. No.: US 2024/0095503 A1
(43) Pub. Date: Mar. 21, 2024

(54) GENERATING EXTREME BUT PLAUSIBLE SYSTEM RESPONSE SCENARIOS USING GENERATIVE NEURAL NETWORKS

(71) Applicant: Nasdaq Technology AB, Stockholm (SE)

(72) Inventors: Johan BERGENUDD, Stocksund (SE); Carl Jonas GUSTAFSSON, Umeå (SE); Conrad JONSSON, Umeå (SE)

(21) Appl. No.: 18/203,732

(22) Filed: May 31, 2023

Related U.S. Application Data
(60) Provisional application No. 63/406,282, filed on Sep. 14, 2022.

(51) Int. Cl. G06N 3/0475; G06N 3/045; G06N 3/094; G06N 3/0985

(52) U.S. Cl. CPC G06N 3/0475; G06N 3/045; G06N 3/094; G06N 3/0985

(57) ABSTRACT

Extreme but plausible system scenarios related to a system are generated using generative neural networks. Evaluation change events for multiple data categories in the system are determined for repeated time intervals over a time period to produce training data, and one or more training data sets are determined based on the training data. An iterative process includes processing noise associated with multiple random variables by a first neural network of a Generative Adversarial Network (GAN) to produce generated input data; processing by a second neural network of the GAN the generated input data and the one or more training data sets to produce a loss value; and modifying the first and second neural networks based on the loss value. The iterative process repeats until the loss value reaches a convergence value resulting in a trained first neural network of the GAN. The trained first neural network generates evaluation change events for the multiple data categories to produce generated change events. The generated change events are filtered to identify extreme but plausible scenarios using a predetermined change measure with one or more predetermined thresholds. Information concerning the extreme but plausible scenarios is provided to a user interface and can be used for system stress testing.

### RELATED APPLICATION

This application claims priority from U.S. provisional patent application No. 63/406,282, filed on Sep. 14, 2022, the contents of which are incorporated herein by reference.

### TECHNICAL OVERVIEW

The subject matter described herein relates to machine learning, sometimes referred to as artificial intelligence, and in particular, machine learning that uses a generative neural network.

### BACKGROUND

Risk management technology is needed in many different types of systems to assess, for example, adequacy of system resources, safety, and reliable system operation to response to extreme scenarios. Typically, risks like system failures, cyber-attacks on the system, etc. are identified and accessed using computer algorithms that statistically analyze historical data. But this approach is limited because future events that adversely impact the system, and extreme but plausible future events may not be identified until they actually occur. Unfortunately, if such extreme events do occur, protective measures likely will not be in place, the stability of the system may be undermined, and significant losses may occur. A technical challenge is how to generate extreme but plausible system response scenarios so that preventive, strengthening, and/or protective measures can be put in place in and/or for the system.

Accordingly, it will be appreciated that new and improved techniques, systems, and processes are continually sought after in these and other areas of technology to address these challenges.

### SUMMARY

In certain example embodiments, extreme but plausible system scenarios related to a system are generated using generative neural networks. Evaluation change events for multiple data categories in the system are determined for repeated time intervals over a time period to produce training data, and one or more training data sets are determined based on the training data. An iterative process includes processing noise associated with multiple random variables by a first neural network of a Generative Adversarial Network (GAN) to produce generated input data; processing by a second neural network of the GAN the generated input data and the one or more training data sets to produce a loss value; and modifying the first and second neural networks based on the loss value. The iterative process repeats until the loss value reaches a convergence value, resulting in a trained first neural network of the GAN. The trained first neural network generates evaluation change events for the multiple data categories to produce generated change events. The generated change events are filtered to identify extreme but plausible scenarios using a predetermined change measure with one or more predetermined thresholds. Information concerning the extreme but plausible scenarios is provided to a user interface and can be used for system stress testing.

This Summary is provided to introduce a selection of concepts that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1 is a diagram of an example system for generating extreme but plausible system response scenarios using generative neural networks according to certain example embodiments;

FIG. 2 is a diagram of a Generative Adversarial Network (GAN) that may be used in the system of FIG. 1 according to certain example embodiments;

FIG. 3A illustrates a flow diagram of a computer-implemented method that may be used by the system in FIG. 1 for generating unknown extreme but plausible simulated system response scenarios according to certain example embodiments;

FIG. 3B illustrates a flow diagram of a computer-implemented method for training GAN models for use in the method of FIG. 3A according to certain example embodiments;

FIG. 4A is a diagram of another Generative Adversarial Network (GAN) that uses conditional flags that may be used in the system of FIG. 1 according to certain example embodiments;

FIG. 4B illustrates a flow diagram of a computer-implemented method for generating unknown extreme but plausible simulated system response scenarios using the conditional flag GAN of FIG. 4A according to certain example embodiments;

FIG. 5 is a diagram of an example server system for generating extreme but plausible system response scenarios using generative neural networks according to certain example embodiments;

FIG. 6A illustrates a flow diagram of a computer-implemented method applied to market data from one or more electronic exchanges for generating unknown extreme but plausible simulated market response scenarios according to certain example embodiments;

FIG. 6B illustrates a flow diagram of a computer-implemented data preprocessing method for use in the method of FIG. 6A applied to input market data from one or more electronic exchanges according to certain example embodiments;

FIGS. 7A-7C show example results achieved by a computer-implemented method applied to market data from one or more electronic exchanges for generating unknown extreme but plausible simulated market response scenarios according to certain example embodiments; and

FIG. 8 shows an example computing system that may be used in some embodiments to implement features described herein.

### DETAILED DESCRIPTION

In the following description, for purposes of explanation and non-limitation, specific details are set forth, such as particular nodes, functional entities, techniques, protocols, etc. to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail.

Sections are used in this Detailed Description solely to orient the reader as to the general subject matter of each section; as will be seen below, the description of many features spans multiple sections, and headings should not be read as affecting the meaning of the description included in any section.

### 1. Overview

Many technical fields benefit from risk management. One example technical field is electronic market exchanges. But risk management is difficult. For the electronic market exchange example, electronic market movements during the Covid pandemic were extraordinary. Consequently, traditional risk computer models did not function well on multiple occasions and failed to accurately predict market movements. In general, traditional risk models depend on historical behavior which renders them ineffective when the risk to be managed is unprecedented compared to historical data.

The inventors solved this problem using generative machine learning networks to generate a wide variety of extreme but plausible system response scenarios. Increasing the number of such scenarios increases the probability of capturing unknown system vulnerabilities to a future unprecedented event, e.g., a crisis.

In example embodiments, evaluation change events for multiple data categories in the system are determined for repeated time intervals over a time period to produce training data, and one or more training data sets are determined based on the training data. An iterative process includes processing noise associated with multiple random variables by a first neural network of a Generative Adversarial Network (GAN) to produce generated input data; processing by a second neural network of the GAN the generated input data and the one or more training data sets to produce a loss value; and modifying the first and second neural networks based on the loss value. The iterative process repeats until the loss value reaches a convergence value, resulting in a trained first neural network of the GAN. The trained first neural network generates evaluation change events for the multiple data categories to produce generated change events. The generated change events are filtered to identify extreme but plausible scenarios using a predetermined change measure with one or more predetermined thresholds. Information concerning the extreme but plausible scenarios is provided to a user interface that may be used for comprehensive and effective risk management.

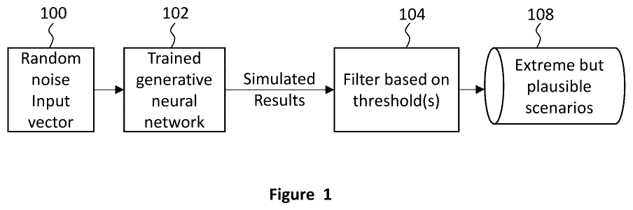

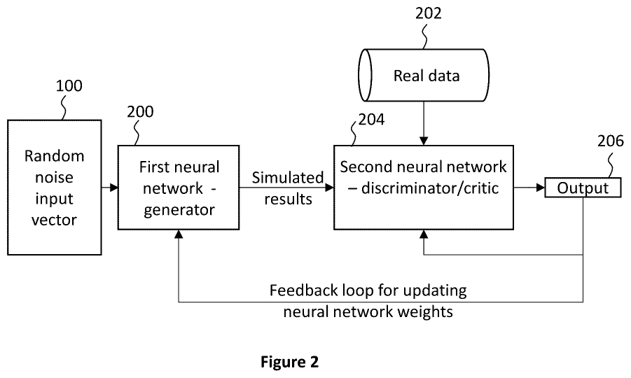

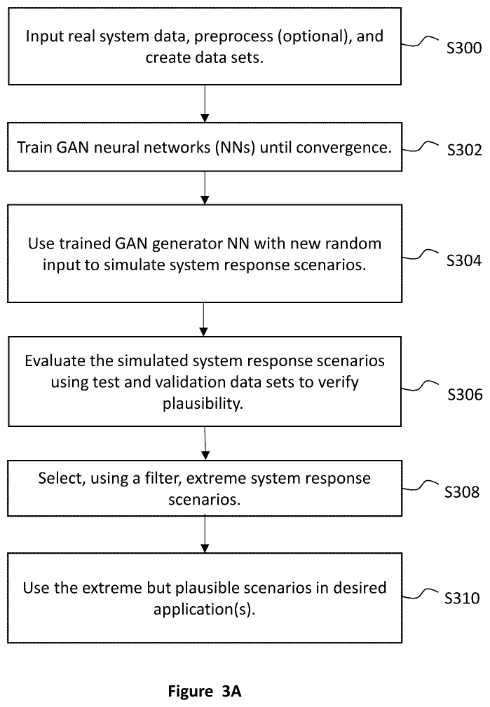

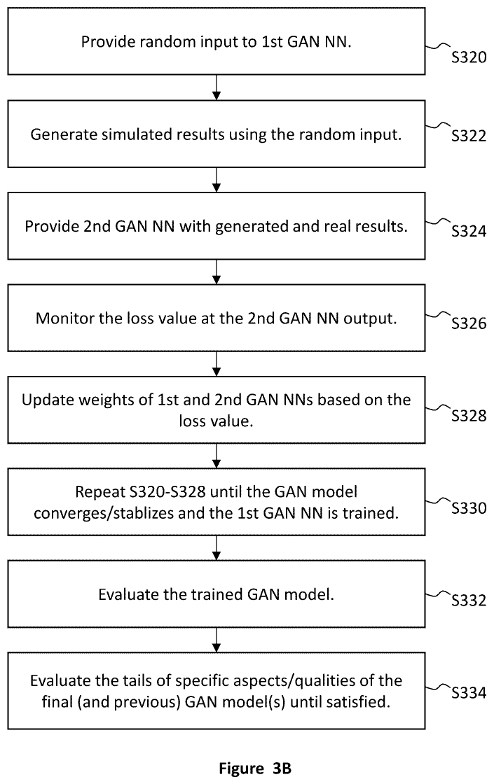

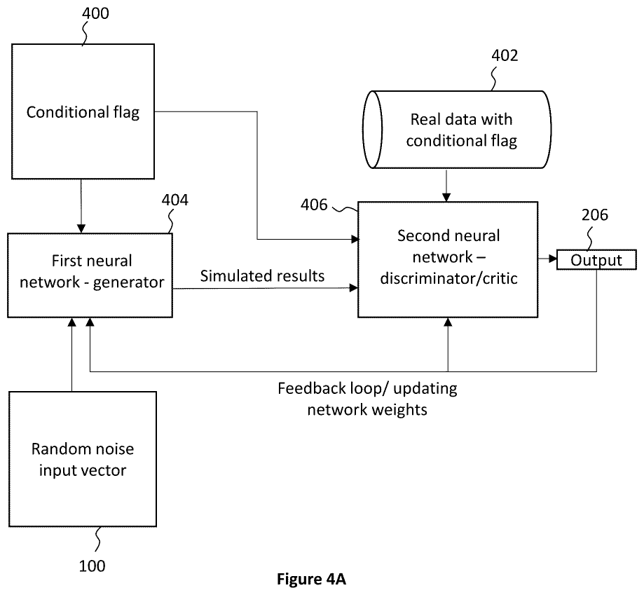

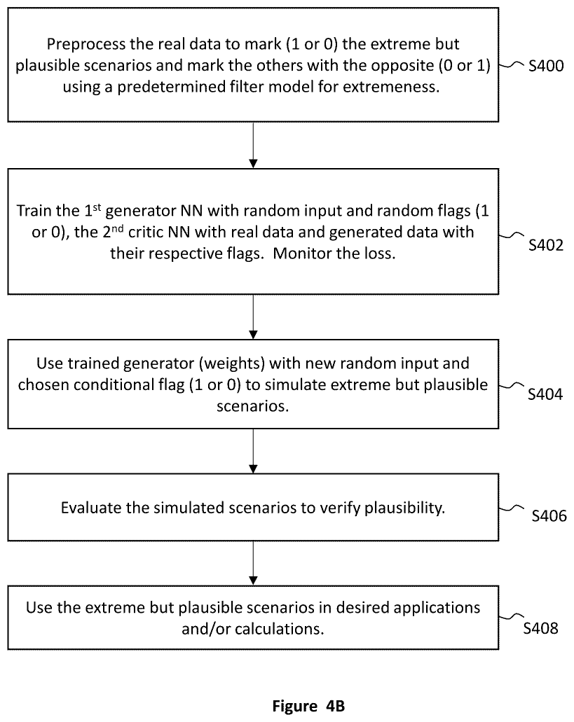

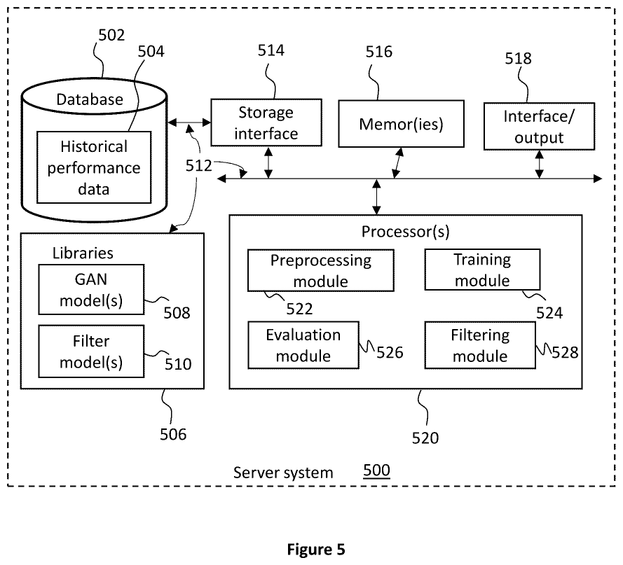

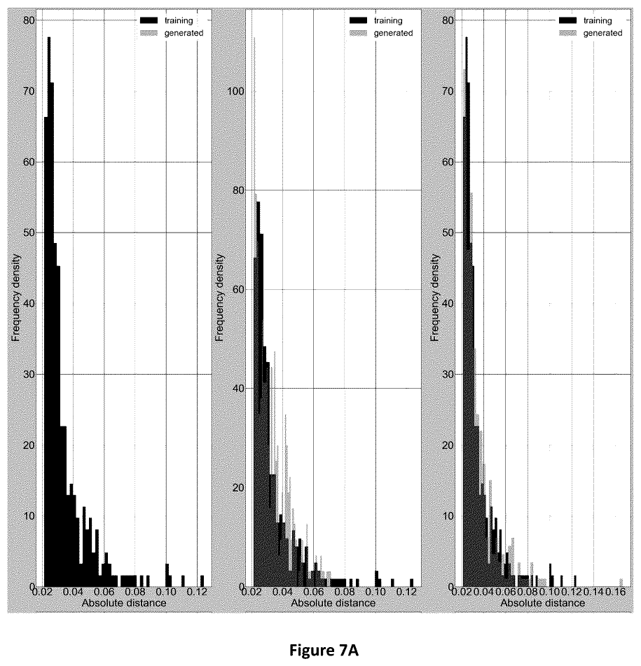

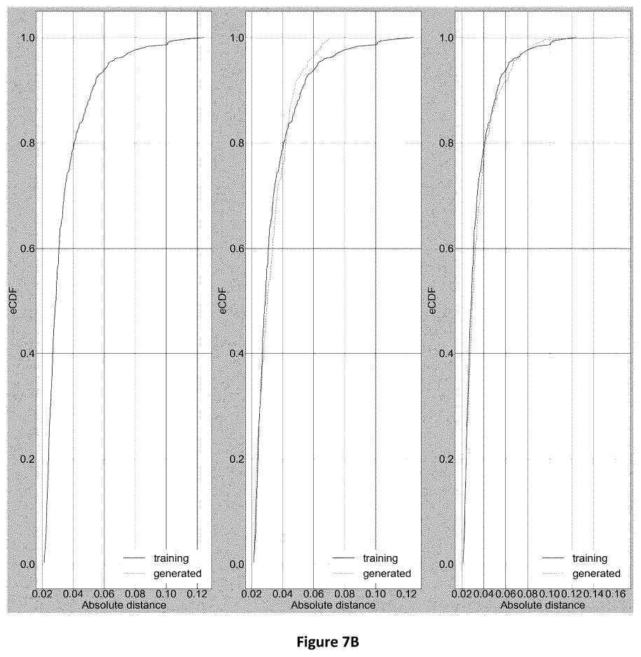

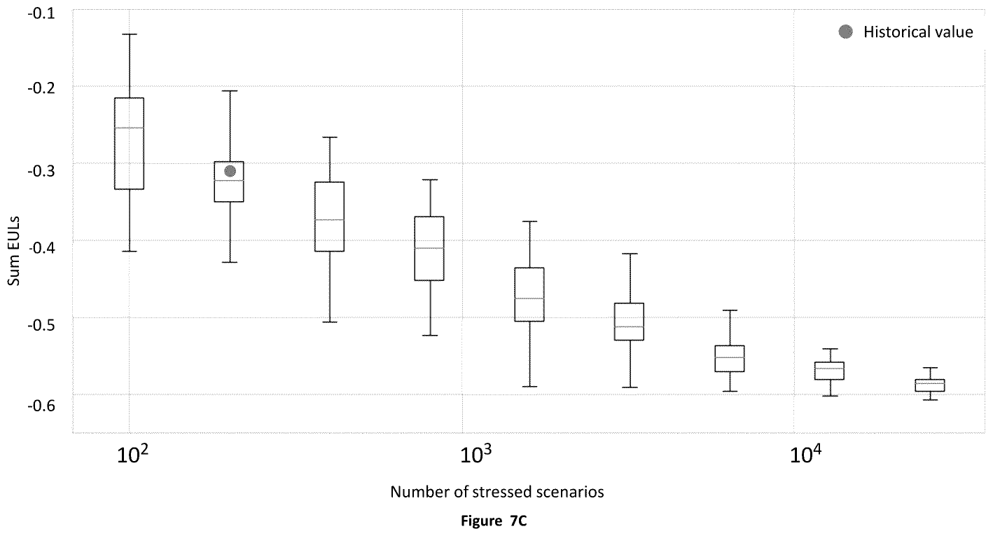

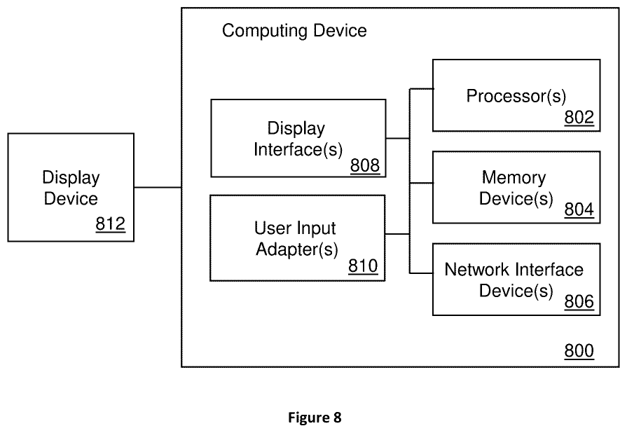

Turning now to an overview of the figures, (each will be described in more detail below), FIG. 1 provides a diagram of an example system for generating several extreme, plausible system response scenarios using generative neural networks in accordance with example embodiments. The generative neural networks in FIG. 1 may be for example a Generative Adversarial Network (GAN) like that shown in FIG. 2. FIG. 3A outlines procedures followed by the system for generating several extreme, plausible system response scenarios, and FIG. 3B outlines network training and evaluation procedures that may be followed by the trained generative neural network 102 in FIG. 2. Another form of GAN that uses conditional flags is described in conjunction with FIGS. 4A-4B and is another example for the trained generative neural network 102 in FIG. 1. The functions of the blocks shown in FIGS. 1, 2, and 4A and the operations shown in FIGS. 3A, 3B, and 4B are implemented using a server system 500 for generating extreme but plausible system response scenarios using generative neural networks shown in FIG. 4. A specific application and implementation of the technology to electronic market exchanges is described in conjunction with the flowcharts in FIGS. 5A-5B. Example advantageous results achieved in this electronic market exchanges application of the system for generating extreme but plausible market response scenarios using generative neural networks are described in conjunction with the graphs shown in FIGS. 7A-7C. FIG. 8 shows an example computing system that may be used to implement the server system 500 for generating extreme but plausible scenarios using generative neural networks.

The system for generating extreme but plausible system response scenarios using generative neural networks provides improvements in system stability and reliability as well as in managing risks in systems.

### 2. Description of FIG. 1—System for Generating Extreme but Plausible System Response Scenarios

In many places in this document, including the description of FIG. 1, computer-implemented function blocks, functions, actions, and/or operations may be implemented using one or more software nodes or module(s). The terms “node” and “module” as used in this document each refer to a computing resource that uses software to execute a computer program or code and/or deploy a computer application. A node or module may be implemented on a virtual machine, a computing process, a computing thread, a module of software code, or a container.

It should be understood that function blocks, operations, signaling, communication of data, and/or other actions performed by node(s) or software module(s) as described in this document are actually implemented by underlying hardware (such as at least one hardware processor and at least one memory device) according to program instructions specified by the software node(s) or module(s); details of an example computer system with at least one hardware processor and at least one memory device are provided in the description of FIG. 8. In addition, the illustrated and/or described nodes, modules, functions, and actions may also be implemented using various configurations of hardware (such as ASICs, PLAs, discrete logic circuits, etc.) alone or in combination with programmed computer(s).

FIG. 1 is a diagram of an example system for generating several extreme, plausible system response scenarios in accordance with example embodiments. A random noise generator 100 generates a random noise input vector that represents multivariate noise (noise associated with multiple variables). That random noise vector is provided to a trained generative neural network 102 comprising input, hidden, and output layers of nodes (or artificial neurons). Each node connects to another and has an associated weight and bias. If the weighted sum generated by a node is above a specified threshold value, that node is activated, sending data to the next layer of the network; otherwise, no data is passed along to the next layer of the network.

The trained generative neural network 102 processes the noise vector to generate simulated results corresponding to simulated system response data. The simulated system response data are received and processed by a filter 104 to select plausible (having a probability at least greater than a minimum system response threshold) system response scenarios (a scenario is a postulated sequence or development of events in the system) that are determined to be extreme (far from a center, normal, or foundational reference) based on one or more system response thresholds. Although one minimum threshold may be used, as described below, example embodiments employ a threshold range with a minimum system response threshold and a maximum system response threshold to define extreme but plausible scenarios. The selected simulated system responses correspond to extreme but plausible scenarios 108 which can be provided to a user interface for use in risk management, stress testing, and other applications.

### 3. Description of FIG. 2—A Generative Adversarial Network (GAN)

The generative neural network 102 in FIG. 1 may be for example a Generative Adversarial Network (GAN) like that shown in FIG. 2, which is sometimes referred to as a GAN model. Other generative neural networks may be used such as variational autoencoders, autoregressive models, Boltzmann machines, etc. A random noise input vector is produced by the random noise generator 100 (like reference numerals refer to like elements throughout the figures) is provided to a first neural network 200, referred to as a “generator” neural network in GAN terminology. In general, to train the generator neural network, a large amount of actual data is collected in a domain of the system of interest and used to train the generator neural network to generate simulated data that is like the actual data. The first neural network 200 is trained through backpropagation using feedback information from the GAN output 206, where training includes to updating network parameters like neural network node weights and biases in the different layers of the first neural network 200 so that it learns the natural or actual features of a dataset related to multiple data categories. Backpropagation is accomplished using a suitable optimization algorithm (“optimizers”) such as for example (but not limited to) one of the following: Stochastic Gradient Descent (SGD), Adaptive moment estimation (Adam), and Root Mean Squared propagation.

The first neural network 200 processes the random noise input vector to generate simulated results corresponding to learned features of multiple data categories within the system being analyzed. These simulated results corresponding to learned features or probability distributions of multiple data categories within the system include simulated system response scenarios.

A second neural network 204 (referred to as a “discriminator” or “critic” neural network in GAN terminology), receives the simulated system response scenarios as well as real or true system data samples 202, e.g., historical real or actual features of the multiple data categories within the system. The second neural network 204 determines a loss value based on a comparison of the simulated results generated by the first generator neural network 200 based on the random noise vector and on the real or true system data samples 202. The second neural network 204 generates the backpropagation feedback for updating the weights and biases of both the first and second neural networks to improve the loss value. The output 206 from the second neural network 204 may be a 0 or 1 if the second neural network 204 is a discriminator or a number if the second neural network 204 is a critic. Once the loss value is below a convergence value, indicating that the first and second neural networks have converged, the trained first neural network 200 can be extracted for use as a trained generative neural network 102 in FIG. 1 to generate system response scenarios that are then filtered to produce extreme but plausible system response scenarios 108.

Thus, in this GAN model, the first generator neural network 200 and the critic neural network 204 compete with the critic trying to distinguish real data samples from “fake” data samples, and the generator trying to create data samples that the critic assesses as real. In an optimal situation (which may not always be present or attainable), a trained generator neural network 200 outputs simulated data samples for the multiple data categories within the system that are substantially indistinguishable for the critic network 204 from the real data samples for the multiple data categories within the system.

GAN hyperparameters are used to control the GAN's learning process and because the GAN is a two-part system, the hyperparameters must be tuned together to achieve optimal performance for the GAN. Example hyperparameters include the learning rate (controls the step size of the optimizer algorithm during training), batch size (controls the number of examples that are processed at once during training), and number of training epochs (i.e., the number of times the entire data set is used during training, where a larger number can lead to better convergence but may result in overfitting, while a smaller number can lead to underfitting).

In example embodiments, the GAN in FIG. 2 may be a Wasserstein GAN (WGAN) that uses a Wasserstein distance, which can be understood as a statistical distance between two probability distributions constrained by a Gradient Penalty (GP). A WGAN-GP may be useful because it is stable and relatively easy to train.

### 4. Description of FIG. 3A—Example Computer-Implemented Method for Generating Unknown Extreme but Plausible Simulated System Response Scenarios

FIG. 3A is a flowchart diagram showing an example computer-implemented method for generating unknown extreme but plausible simulated system response scenarios. In step S300, real system data samples including evaluation change events for multiple data categories in the system being analyzed are input and preprocessed to create one or more training data sets. Although preprocessing is optional, it can be useful in creating more effective training data sets. Then, in step S302, the GAN neural networks are trained into convergence. In step S304, the trained GAN generator neural network processes new random input vector values to simulate system response scenarios.

In step S306, these simulated system response scenarios are evaluated using test and validation data sets to verify the plausibility of these simulated system response scenarios. The test and validation data sets may be provided by or generated from a subset of the training data. The test and validation data sets may be compared one or multiple times with generated simulated system response scenarios of the same size as the test or validation set or of different size than the test or validation set. The comparison may use statistical measures or classifiers or more ad hoc methods and tools. Plausibility may be determined by using statistical measures such as maximum mean discrepancy or classifiers such as a random forest classifier or a separate neural network classifier. The plausibility evaluation may be used with training, validation, and/or test datasets.

In step 308, a filtering algorithm or model is used to process plausible simulated system response scenarios to select extreme system response scenarios by comparing the simulated scenarios to an extreme threshold range; however, as mentioned above, a minimum extreme scenario threshold could be used. An extreme threshold range with a minimum extreme scenario threshold and a maximum extreme scenario threshold may provide more accurate results by placing bounds on the generative neural network's produced simulated response scenarios. The filter may be for example a Euclidean distance filter, where distance refers to a statistical distance between two probability distributions. The filter identifies scenarios that lead to large or extreme movements and losses in the system. In step S310, the selected extreme system response scenarios may be used in one or more applications such as stress testing, risk management, risk calculations, etc.

### 5. Description of FIG. 3B—Example Computer-Implemented Method for Training a GAN

FIG. 3B illustrates a flow diagram of a computer-implemented method for training a GAN for use in the method of FIG. 3A according to certain example embodiments. In step S320, a random noise input vector is provided to a first GAN neural network. The first GAN neural network generates simulated results (system response scenarios) based on the random input as indicated in step S302. The first GAN neural network provides a second GAN neural network with simulated system response scenario data and the real system response scenario data. In step S326, the loss value of the second GAN neural network is monitored to see whether the loss value reaches a convergence value. If not, the GAN neural networks have not converged, and in step S328, the weights and biases of the 1st and 2nd GAN neural networks are updated/modified based on the loss value, and steps S320-S328 are repeated until the GAN model converges or stabilizes as indicated when the loss value reaches the convergence value as indicated in step S330.

At step S332, the trained GAN model is evaluated, e.g., with the validation or testing methods described above using measures or classification algorithms based on validation or test data sets to verify some degree of plausibility of the trained GAN model. One example evaluation shown in step S334 is to evaluate the “tails” of specific aspects or qualities of the final trained GAN model, and in some embodiments, of the final trained GAN model and previous GAN models. A “tail” refers to the end (or rare or unlikely) part of the distribution of an evaluation or test statistic being used for evaluating the GAN models. A GAN model may be evaluated as well-trained when it models specific aspects relating to rare observations and/or occurrences to generate new, not previously seen, but plausible scenarios.

A particular example of a possible WGAN-GP training algorithm is now provided. This example assumes default values of λ=10, which is a constant the regulates how strong the gradient penalty should be; nc_{CRITIC}=5, which informs how many times the second neural network (critic) weights should be updated for each time the first neural network (generator) weights are updated; Optimizer: Adam; η_{G}=η_{C}=0.0001, these constants depict the learning rate for the first neural network (generator) and the second neural network (critic) respectively (which in this example are the same); β₁=0, β₂=0.9, the β parameters are parameters specific to the optimizer “Adam” to control specific features of the Adam adaptive learning rate optimization algorithm for training neural networks; where all operations on vectors are element-wise.

Require: A: the gradient penalty coefficient
Require: n_{critic}: the number of critic iterations per generator iteration
Require: m: batch size
Require: Optimizer and its hyperparamters
Require: W: initial parameters of the critic
Require: θ: initial parameters of the generator
Require: p₂: the latent noise distribution

| | |
|---|---|
| 1: | while θ not converged do |
| 2: | for i = 1, . . . , n_{critic} do |
| 3: | Sample real data {x}ᵢ₌₁^{m}~p_{data} |
| 4: | Sample latent variables {z}ᵢ₌₁^{m}~p_{z} |
| 5: | Sample random numbers {ϵ}ᵢ₌₁^{m}~U[0, 1] |
| 6: | \hat{x} ← f_{θ}(z) |
| 7: | \hat{x} ← ϵ · x + (1 − ϵ) · \hat{x} |
| 8: | $L = \frac{1}{m} {\sum }_{i = 1}^{m} ( fw ( {\hat{x}}_{i} ) - fw ( {x}_{i} ) + λ \cdot ( {( {‖ {∇}_{{\tilde{x}}_{i}} fw ( {\tilde{x}}_{i} ) ‖}_{2} - 1 )}^{2} ) )$ |
| 9: | W ← Optimizer(∇_{W}L, W, optimizer hyperparameters; |
| | η_{G}, η_{C}, β₁, β₂, etc.) |
| 10: | end for |
| 11: | Sample (new) batch of latent variables {z}ᵢ₌₁^{m}~p(z) |
| 12: | $θ ← Optimizer ( {∇}_{θ} \frac{1}{m} {\sum }_{i = 1}^{m} - fw ( {f}_{θ} ( {z}_{i} ) ) , θ , optimizer$ |
| | hyperparameters; η_{G}, η_{C}, β₁, β₂, etc.) |
| 13: | end while |
| 14: | return θ |

The above WGAN-GP algorithm is an example for training a GAN model to convergence. It essentially shows FIG. 2 in an algorithmic way, with added details regarding the gradient penalty (steps 5, 7, and part of 8). The algorithm at step 3 samples a data batch of real data (e.g., multiple data types for multiple data categories) and then samples a batch of noise data and a batch of uniform data (used for the gradient penalty). At step 6, a batch of simulated results using the first neural network is created. At step 7, this batch of simulated results is interpolated with the real data batch using the uniform random data created above. At step 8, a loss value is then calculated including the gradient penalty. At step 9, the weights of the second neural network (critic) are updated using the optimizer algorithm. Furthermore, at step 11, a new batch of noise data is created. Step 12 performs a loss value calculation for the first neural network based on new simulated results and updates the first neural network weights using the optimizer algorithm.

### 6. Description of FIGS. 4A and 4B—Example GAN That Uses Conditional Flags

FIG. 4A is a diagram of another example Generative Adversarial Network (GAN) that uses conditional flags that may be used for the generative neural network 102 in the system of FIG. 1 according to certain example embodiments.

A random noise input vector is produced by the random noise generator 100 and is provided to a first generator neural network 404. Additionally, a conditional flag 400 is provided to a first neural network 404 as a second input indicating the desired severeness of the scenario to be generated. In many applications, a large amount of actual data may be collected in a domain of the system of interest and used to train the generator neural network to generate simulated data that is like the actual data. The first neural network 404 is trained through backpropagation using feedback information from the GAN model output 408, where training includes updating network parameters like neural network node weights and biases in the different layers of the first neural network 404 so that the neural network learns the real or actual features of a dataset related to each of multiple data categories. Backpropagation is accomplished using a suitable optimization algorithm (“optimizers”) such as for example (but not limited to) one of the following: Stochastic Gradient Descent (SGD), Adaptive moment estimation (Adam), and Root Mean Squared propagation.

The first neural network 404 processes the random noise input vector together with a random conditional flag, indicating the desired severeness of the scenario to be generated, to generate simulated returns corresponding to learned features of multiple data categories within the system being analyzed. A second neural network 406 (referred to as a “discriminator” or “critic”) receives the simulated returns together with the same conditional flag the first network received. The second neural network 406 also receives real or true system data samples 402 each of which contains a conditional flag indicating the desired severeness of the scenario to be generated. The second neural network 406 determines a loss value based on a comparison of the simulated results generated by the first neural network 404 based on the random noise vector and on the real or true system data samples 402. The second neural network 406 generates the back propagation feedback for updating the weights and biases of both the first and second neural networks to improve the loss value. Once the loss value is at a satisfactory level, indicating that the first and second neural networks have converged, the trained first neural network 404 can be used as a trained generative neural network 102 as in FIG. 1 to generate plausible (and possibly extreme but plausible) system response scenarios that may be filtered to produce extreme but plausible system response scenarios 108 as shown in FIG. 1. In an example embodiment the conditional GAN in FIG. 4A may be a Wasserstein GAN that uses a Wasserstein statistical distance.

FIG. 4B illustrates a flow diagram of a computer-implemented method for generating unknown extreme but plausible simulated system response scenarios using the conditional flag GAN of FIG. 4A according to certain example embodiments. In step S400, the real system data is preprocessed to mark or flag (e.g., with a 1 or 0 bit) extreme but plausible scenarios and to mark other scenarios which are not extreme with another flag value (e.g., 0 or 1) using a predetermined filtering model that filters the scenarios to identify extreme scenarios, e.g., using one or more extremeness thresholds. In step S402, a first generator neural network is trained with random input and random flags, and the second critic neural network is trained with real data and generated data from the first neural network with their respective corresponding flags. The loss is monitored. In step S404, the trained first generator neural network processes new random input and a chosen conditional flag to simulate extreme but plausible scenarios. Step S406 evaluates the simulated scenarios to verify plausibility. In step S408, those extreme but plausible scenarios are then used in desired applications, calculations, etc.

### 7. Description of FIG. 5—An Example Server System

FIG. 5 is a diagram of an example server system for generating extreme but plausible system response scenarios using generative neural networks according to certain example embodiments. In some embodiments, the server system 500 may be a stand-alone system, cloud-based, and/or software as a service-based. The server system 500 includes more or more processors 520, a database 502, digital software libraries 506, one or more memor(ies) 516, a communication interface 518, and a storage interface 514, all of which communicate with each other via one or more buses 512. The database 502 and/or libraries 506 may be located near the processor(s) 520 or remote therefrom. The server system 500 may include fewer or more components than those depicted in FIG. 5.

In example embodiments, the database 502, accessible by the processors 500 via the storage interface 514, stores historical system performance data 504 for extreme and other scenarios that have already occurred. The libraries 506, also accessible by the processors 500 via the storage interface 514, include one or more GAN models 508 and one or more scenario filtering models 510 as described above.

The processor(s) 520 are operatively coupled to the communication interface 518 for communication with one or more devices (not shown in the figure) such as one or more user interfaces and/or devices connected to a communications network like the Internet.

In example embodiments, the processor(s) 520 include a data pre-processing module 522, a training module 524, an evaluation module 526, and a filtering module 528. Programs and data associated with the operations of one or more of the processors 520 may be stored in the memor(ies) 516. The data pre-processing module 522 pre-processes input multivariate noise data and real/actual system data. The pre-processing module 522 converts the real/actual system data into return data of logarithmic or simple return type, and it may also standardize the data. The training module 524 performs the training operations described above in conjunction with the GAN model(s) 508 in the library 506. The evaluation module 526 evaluates the simulated system response scenarios using test and validation data sets to verify their plausibility. The filtering module 528 uses one or more filtering models 510 in the library 506 to process the simulated scenarios and identify extreme but plausible system response scenarios.

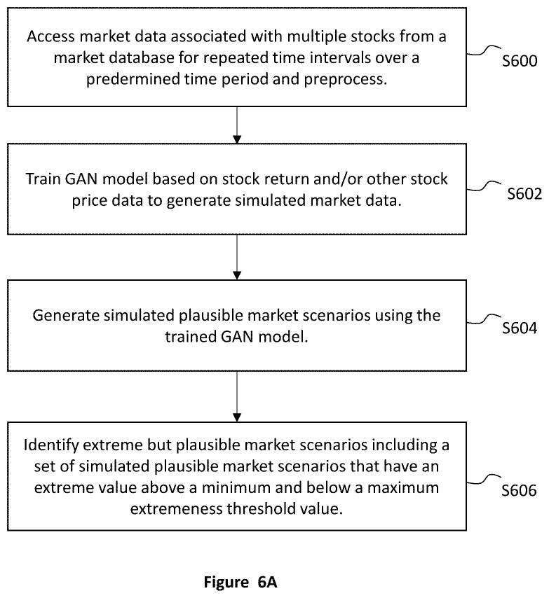

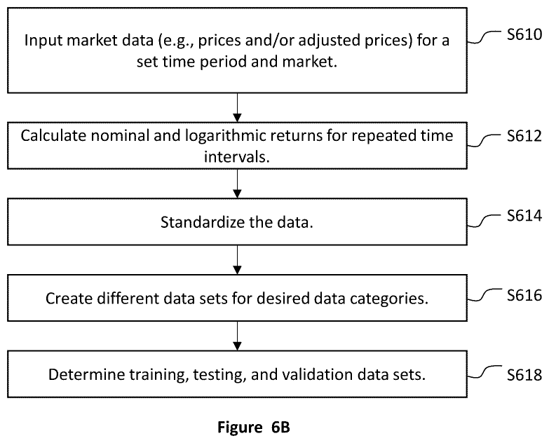

### 8. Description of FIGS. 6A and 6B—An Example Application to an Electronic Market System

An example application for the above technology is to calculate the size of a default fund and the clearing capital needed for a clearinghouse in an electronic market system. Both the default fund and the clearing capital are regulatory requirements associated with the market system. Margin requirement calculations are performed by clearinghouses to determine the minimum amount of collateral that all counterparties must pledge to cover “bad market movements,” e.g., during a default situation. In addition, a clearinghouse must maintain a default fund to cover a default under extreme, but plausible market movements. The size of the default fund is typically set to the worst-case uncollateralized loss in a “stress test” calculation, where it is assumed that either the largest, or the second plus third largest counterparty default. “Uncollateralized” means that the stressed loss is reduced by the pledged margin. For the clearing capital, it is typically set to the worst-case uncollateralized loss for the two largest counterparties.

A technical challenge is that the amount of training data for the algorithm is typically limited because of the definition of extreme but plausible scenarios (e.g., selecting the worst 4% of historical scenarios). For example, 20 years of historical scenarios (i.e., they actually occurred) may provide around 200 extreme but plausible scenarios. If more than 4% of the worst historical scenarios are selected, the simulated scenarios will be less extreme and may not be as useful depending on the final objective.

Using neural networks to replicate commonly used models to arrive at the same result (historical extreme market scenarios) does not provide helpful information for a clearinghouse to predict unknown unknowns, e.g., “black swans.” Training neural networks with historical data may not predict the unknown unknowns, and replicating commonly used models does not improve risk management for a clearinghouse.

In contrast, using the technology described above, a WGAN model is trained using historical market movements. The trained network is then able to generate hypothetical market movements that resemble actual market movements. By generating a sufficient number of such scenarios, and selecting those scenarios that are sufficiently extreme (e.g., using a Euclidean distance to set a lower threshold, and optionally also using a Euclidean distance to set an upper threshold), any number of extreme but plausible scenarios can be obtained. Processing those generated scenarios using a stress testing algorithm and algorithms for determining clearing capital and default fund size provide a more robust result. As shown in FIG. 7C, described below, the total Expected Uncollateralized Loss (EUL) increases with a higher number of stressed (extreme but plausible) scenarios used. The difference between margin requirements and worst-case EUL of an account may be used to determine additional margin (add-on) to be pledged.

FIG. 6A illustrates a flow diagram of a computer-implemented method applied to market data from one or more electronic exchanges for generating unknown extreme but plausible simulated market response scenarios according to certain example embodiments. In this example application, example data categories include monitored securities, e.g., stocks, bonds, commodities, derivatives, etc. traded on one or more electronic exchanges. Multiple types of data for each monitored security may include one or more of the following: daily opening price, high daily price, low daily price, closing daily price, and/or adjusted closing daily price. The monitoring time period may be one or more years, e.g., 25 years, or other suitable time period. The training data may include one or more of: normalized logarithmic returns for each monitored security, normalized simple returns for each monitored security, logarithmic returns for each monitored security, and simple returns for each monitored security. Evaluation change events may include price swings for multiple portfolios of securities identified from historical databases associated with trading of those portfolio securities.

In step S600, market data including the various types of data for portfolios of stocks (in this example) mentioned above are accessed by one of the processing modules 520 from the historical database 502 associated with multiple securities for repeated time intervals over a predetermined time. This accessed market data may be preprocessed by the preprocessing module 522 to return data of logarithmic or simple return type, which may also be standardized. In step S602, the training module 524 trains a WGAN-GP model, e.g., as described in embodiments above, based on stock return and price data for the multiple stocks to generate simulated market data. A goal is to train the WGAN-GP model to approximate the multidimensional return distribution of a market of reasonable size and thereby be able to generate new, unknown but realistic market data. The following are example hyperparameters for the WGAN-GP models:

| Hyperparameter | Value |
|---|---|
| Optimizer | RMSprop |
| Critic learning rates | [8e−4, 2e−4, 5e−5] |
| Critic learning rate schedule | [5000, 5000, inf] |
| Genera\|tor learning rates | [1e−6, 5e−7] |
| Generator learning rate schedule | [10 000, inf] |
| Noise type | Student's t-distribution |
| Degrees of freedom | 3.5 |
| Batch size | 32 |
| λ | 10 |
| n_{critic} | 1 |

Differences in hyperparameters between different WGAN-GP models based on different number of assets (stocks) may, in an example, only be the input noise dimension and the network architectures. The input noise vector in this example is derived from the Student's t-distribution, i.e., sampling from a multivariate probability distribution. One example test included five stocks with a baseline input noise vector with 100 dimensions. For larger example models of 50, 100, and 344 stocks tested, the same proportion of number of stocks to baseline noise dimension was not required; but the noise dimension was kept larger than the output dimension of the GAN model. For the 50 stock model, the input noise dimension was 300, for the 100 stock model, the input noise dimension was 400, and for the 344 stock model, the input noise dimension was 600. Thus, the noise dimension is variable across GAN models with different market sizes or stock numbers. The input noise vector dimension may be higher than the market data input size, which corresponds to the number of stocks or market size and which determines the size of the first input layer in the first generator neural network of the GAN model.

In step S604, one or more of the processors 520 use the trained first neural network of the WGAN-GP model to generate simulated possible market scenarios. In step S606, the filter module 526, using the filtering model(s) 510, processes simulated plausible market scenarios to identify extreme but plausible market scenarios based on a set of historical plausible market scenarios having an extreme value above a minimum extremeness threshold and below a maximum extremeness threshold.

FIG. 6B illustrates a flow diagram of a computer-implemented data preprocessing method for use in the method of FIG. 6A applied to input market data from one or more electronic exchanges according to certain example embodiments. In step S610, market data, such as daily stock prices or adjusted daily stock prices, is input for a set time period (e.g., one year, 25 years, etc.) and for a particular electronic market. In step S612, nominal and/or logarithmic returns for each of the stocks are calculated for repeated time intervals, e.g., daily returns. In step S614, the data is standardized, e.g., the mean for each stock is removed and then divided by the stock's standard deviation. Different data sets are then generated for desired stocks in step S616. Step S616 includes determining the scope of the training data, which, and what number of securities/assets to include, and how to structure the input data to the WGAN model to determine what may be included in the generated output. This determination may also be based on the securities included in the target portfolios. If the total number of securities may exceed the capabilities of the WGAN model, that total number may also be limited and/or the desired market data may be divided into smaller sets. The number of assets (e.g., the number of stocks being analyzed) decides the noise dimension.

In step S618, training, test, and validation data sets are determined from the generated data sets in step S616. In the context of machine learning, a data set may be divided into three parts: a training set, a validation set, and a test set. The training set, which constitutes the largest portion of the data set in this example, e.g., ranging from 60-80% of the total data set, is used to train the WGAN model so that it learns patterns and relationships based on this data. The validation set, e.g., about 10-20% of the total data set, is used to tune WGAN model parameters and choose the best performing WGAN model during the training process. The validation set provides a measure of performance and helps prevent overfitting, which occurs when the WGAN model learns the training data too well and performs poorly on unseen data. Finally, the test set, which may also be around 10-20% of the total data set, is used after the WGAN model is fully trained and tuned to evaluate the WGAN model's performance on completely unseen data. This provides an unbiased measure of the WGAN model's effectiveness. To summarize, the training set is for learning, the validation set is for model selection and tuning, and the test set is for the final unbiased evaluation.

### 9. Description of FIGS. 7A-7C—Example Results Achieved

FIGS. 7A-7C show example results achieved by a computer-implemented method applied to market data from one or more electronic exchanges for generating unknown extreme but plausible simulated market response scenarios according to certain example embodiments related to the examples from FIGS. 6A and 6B described above.

FIG. 7A shows the development of specific tail features of the generator neural network output during training, and in particular, an increased tail distance of a test stock portfolio's returns, where the test stock portfolio is based on a 344 stock historical data set of returns. FIG. 7A contains normalized histogram plots of the distance between the tail of the stock portfolio return distribution and the mean return of the stock portfolio. Distance is displayed on the x-axis, and the frequency density function on the y-axis. The training stock return data is represented in black histograms, and the generated (simulated) stock return data is represented as gray histograms. The leftmost graph shows only the training stock return data because training of the WGAN model has not yet begun; the middle graph shows the fit of the generated stock return data halfway through training of the WGAN model, and the rightmost graph represents the fully trained WGAN model.

Moving from left to right, the improvements in capturing the tails of the distribution can be seen through the decreased distance between the two distributions, and by the rightmost graph “fitting” the training distribution in a better way. The modeled extreme market events or scenarios are represented in the tails (the ends) of the distribution graphs. Accordingly, it is important that the tails are modeled accurately, i.e., the two distributions are similar.

A specific example is now provided based on an example stock portfolio, a set of historical market return scenarios, and a set of generated market return scenarios for the example stock portfolio. The 150 largest and 150 smallest returns of the example stock portfolio for the historical scenarios are identified. The distances are calculated between these returns and the mean of the stock portfolio return [symbol] ={|rᵢ−\hat{μ}ₚ|}ᵢ₌₁³⁰⁰, where

$$\\ {\hat{μ}}_{p} = \frac{1}{n} {\sum }_{i = 1}^{n} {p}_{i} ,$$

pᵢ is the stock portfolio return of historical observation i, and rᵢ are the 150 largest and 150 smallest returns. Then, the minimum of this set of distances was calculated LB_{D}=min( [symbol] ). For the generated data, the distance from each data point to the mean, \hat{μ}ₚ, of the stock portfolio return was calculated dᵢ=|rᵢ^{(g)}−\hat{μ}ₚ|, where rᵢ^{(g)} are the stock portfolio returns created from the generated data, and then the set [symbol] _{g} can be created, [symbol] _{g}={dᵢ:dᵢ≥LB_{D}}ᵢ₌₁^{m}, where dᵢ is the distance of interest and m was the number of generated observations. The sets [symbol] and [symbol] _{g} are plotted as histograms, as shown in FIG. 7A.

FIG. 7B shows a corresponding empirical cumulative distribution function (eCDF) to FIG. 7A (FIGS. 7A and 7B have the same x-axis). FIG. 7B is an alternative approach to FIG. 7A for visualizing the same data. On the x-axis, the distance is displayed, and on the y-axis, the eCDF is displayed. The training data is represented in the black line, and the generated data is represented as the dashed line. There is no generated data dashed line in the leftmost graph at the start of training. The goal is for the black and dashed lines to be as close to each other as possible. FIG. 7B is constructed in the same way as FIG. 7A, where the evolution of the WGAN model output data can be seen throughout the training time.

FIGS. 7A and 7B illustrate one example advantageous aspect of the trained WGAN model: it accurately represents the tail distribution of the stock portfolio. As explained above, the tail representation is significant for generating extreme but plausible market scenarios in this example specific application under consideration.

Regarding FIG. 7C, the following definitions are provided. For a stock portfolio, the Expected Uncollateralized Loss (EUL) is defined as follows, EUL=STV−Margin Requirement, where STV is the Stress Test Value which is the loss that can occur in the stock portfolio for an extreme but plausible market scenario, and Margin Requirement is the margin requirement collected for that portfolio.

FIG. 7C shows some results for an example stress testing procedure calculated for both historical and generated extreme but plausible scenarios for six example stock portfolios and a set of extreme but plausible market scenarios. Based on the six example stock portfolios and the set of extreme but plausible market scenarios, the worst expected uncollateralized loss (EUL) is calculated for each stock portfolio; for six stock portfolios, there are six EUL numbers. The sum of these six EULs is then calculated. For the historical extreme but plausible scenarios, this sum is determined once since there is only one set of historically extreme but plausible scenarios. This sum of six EULs for the one set of historically extreme but plausible scenarios is represented as a dot in FIG. 7C.

For the generated extreme but plausible scenarios, an example of 30 sets of example stock portfolios and an example set of 200 extreme but plausible scenarios are used. Based on the 30 sets of example stock portfolios and the set of 200 extreme but plausible market scenarios, a worst expected uncollateralized loss (EUL) is calculated for each of the 30 stock portfolios. Thus, for 30 stock portfolios, there are 30 EUL numbers. Each box plot in FIG. 7C represents the 30 EUL numbers. This procedure is then performed 30 more times with a new set of generated extreme but plausible scenarios each time to calculate a sum of EULs. More generally, the procedure of calculating this sum of EULs can be represented as

$$\\ {EUL}_{sum} = {\sum }_{i = 1}^{p} {max}_{s} ( {EUL}_{sp} ) ,$$

where EULₛₚ represents a matrix with s-scenarios and p-portfolios.

FIG. 7C displays a graph with 9 box plots calculated with the procedure described above. Each of the 9 box plots represents 30 summed EUL values created with the procedure described above for a fixed number of generated extreme but plausible scenarios. In this example, there are 200 historical extreme but plausible scenarios (the x-axis shows the number of extreme but plausible scenarios). Each box plot shows a highest and lowest summed EUL value as “whisker” lines at the ends of each vertical line of the box plot, the first and third quartiles define the box portion of the box plot, and the line in each box portion shows the median summed EUL value. The number of generated stressed scenarios are 100, 200, 400, 800, 1600, 3200, 6400, 12800, and 25600, and they are displayed on the x-axis using a log-scale. The historical calculation is the box plot with the dot.

In summary, 30 sets of a fixed number, e.g., 800, extreme but plausible market scenarios are generated using a trained first neural network (generator) based on a WGAN model. For each set of extreme but plausible market scenarios, the worst EUL is calculated for each stock portfolio, and those worst EUL values are summed into one summed worst EUL value for each set of extreme but plausible market scenarios, leading to a total of summed worst EUL 30 values, which is represented as a box plot in FIG. 7C.

The results in FIG. 7C show that using the technology described in this application to generate new extreme but plausible scenarios provides more nuance in the risk analysis. The stress testing procedure described above shows that with more extreme but plausible scenarios, the stress test value shows larger potential losses. Accordingly, the technology described in this application provides improved risk management because larger potential losses are identified as plausible so that preventive and/or safeguard measures can be taken (e.g., increased margins). Furthermore, some variation can be created as compared with being limited to calculating one value based on the 200 historical extreme but plausible scenarios.

### 10. Description of FIG. 8—Example Computing System

FIG. 8 shows an example computing system that may be used in some embodiments to implement features described herein including each of FIGS. 1-6B. An example computing device 800 (which may also be referred to, for example, as a “computing device,” “computer system,” or “computing system”) includes one or more of the following: one or more hardware processors 802; one or more memory devices 804; one or more network interface devices 806; one or more display interfaces 808; and one or more user input adapters 810. Additionally, in some embodiments, the computing device 800 is connected to or includes a display device 812. As will explained below, these elements (e.g., the hardware processors 802, memory devices 804, network interface devices 806, display interfaces 808, user input adapters 810, display device 812) are hardware devices (for example, electronic circuits or combinations of circuits) that are configured to perform various functions for the computing device 800.

In some embodiments, each or any of the hardware processors 802 is or includes, for example, a single-core or multi-core hardware processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 802 uses an instruction set architecture such as x86 or Advanced RISC Machine (Arm).

In some embodiments, each or any of the memory devices 804 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 802). Memory devices 804 are examples of non-volatile computer-readable storage media.

In some embodiments, each or any of the network interface devices 806 includes one or more circuits (such as a baseband processor and/or a wired or wireless transceiver), and implements layer one, layer two, and/or higher layers for one or more wired communications technologies (such as Ethernet (IEEE 802.3)) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all the circuitry in the housing to perform transmission and reception. In some embodiments, the transmitter and receiver of a transceiver may not share any common circuitry and/or may be in the same or separate housings.

In some embodiments, each or any of the display interfaces 808 is or includes one or more circuits that receive data from the hardware processors 802, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device 812, which displays the image data. Alternatively or additionally, in some embodiments, each or any of the display interfaces 808 is or includes, for example, a video card, video adapter, or graphics processing unit (GPU).

In some embodiments, each or any of the user input adapters 810 is or includes one or more circuits that receive and process user input data from one or more user input devices (not shown in FIG. 8) that are included in, attached to, or otherwise in communication with the computing device 800, and that output data based on the received input data to the hardware processors 802. Alternatively or additionally, in some embodiments each or any of the user input adapters 810 is or includes, for example, a PS/2 interface, a USB interface, a touchscreen controller, or the like; and/or the user input adapters 810 facilitates input from user input devices (not shown in FIG. 8) such as, for example, a keyboard, mouse, trackpad, touchscreen, etc.

In some embodiments, the display device 812 may be a Liquid Crystal Display (LCD) display, Light Emitting Diode (LED) display, or other type of display device. In embodiments where the display device 812 is a component of the computing device 800 (e.g., the computing device and the display device are included in a unified housing), the display device 812 may be a touchscreen display or non-touchscreen display. In embodiments where the display device 812 is connected to the computing device 800 (e.g., is external to the computing device 800 and communicates with the computing device 800 via a wire and/or via wireless communication technology), the display device 812 is, for example, an external monitor, projector, television, display screen, etc.

In various embodiments, the computing device 800 includes one, or two, or three, four, or more of each or any of the above-mentioned elements (e.g., the hardware processors 802, memory devices 804, network interface devices 806, display interfaces 808, and user input adapters 810). Alternatively or additionally, in some embodiments, the computing device 800 includes one or more of: a processing system that includes the hardware processors 802; a memory or storage system that includes the memory devices 804; and a network interface system that includes the network interface devices 806.

The computing device 800 may be arranged, in various embodiments, in many different ways. In various embodiments, the computing device 800 includes one, or two, or three, or four, or more of each or any of the above-mentioned elements (e.g., the processors 802, memory devices 804, network interface devices 806, display interfaces 808, and user input adapters 810). Alternatively, or additionally, in some embodiments, the computing device 800 includes one or more of: a processing system that includes the processors 802; a memory or storage system that includes the memory devices 804; and a network interface system that includes the network interface devices 806. Alternatively, or additionally, in some embodiments, the computing device 800 includes a system-on-a-chip (SoC) or multiple SoCs, and each or any of the above-mentioned elements (or various combinations or subsets thereof) is included in the single SoC or distributed across the multiple SoCs in various combinations. For example, the single SoC (or the multiple SoCs) may include the processors 802 and the network interface devices 806; or the single SoC (or the multiple SoCs) may include the processors 802, the network interface devices 806, and the memory devices 804; and so on. Further, the computing device 800 may be arranged in some embodiments such that: the processors 802 include a multi- (or single)-core processor; the network interface devices 806 include a first short-range network interface device (which implements, for example, WiFi, Bluetooth, NFC, etc.) and a second long-range network interface device that implements one or more cellular communication technologies (e.g., 3G, 4G LTE, CDMA, etc.); and the memory devices 804 include a RAM and a flash memory. As another example, the computing device 800 may be arranged in some embodiments such that: the processors 802 include two, three, four, five, or more multi-core processors; the network interface devices 806 include a first network interface device that implements Ethernet and a second network interface device that implements WiFi and/or Bluetooth; and the memory devices 804 include a RAM and a flash memory or hard disk.

As previously noted, whenever it is described in this document that a software-based node, module, or process (each being referred to as a “component” below for ease of description) performs an action, operation, or function, the action, operation, or function is in actuality performed by underlying hardware elements according to the instructions used to implement the node, module, or process. In such embodiments, the following applies for each component: (a) the elements of the 800 computing device 800 shown in FIG. 8 (i.e., the one or more hardware processors 802, one or more memory devices 804, one or more network interface devices 806, one or more display interfaces 808, and one or more user input adapters 810), or appropriate combinations or subsets of the foregoing) are configured to, adapted to, and/or programmed to implement each or any combination of the actions, activities, or features described herein as performed by the component and/or by any software nodes, processes, or modules described herein as included within the component; (b) alternatively or additionally, to the extent it is described herein that one or more software nodes, processes, or modules exist within the component, in some embodiments, such software nodes, processes, or modules (as well as any data described herein as handled and/or used by the software nodes, processes, or modules) are stored in the memory devices 804 (e.g., in various embodiments, in a volatile memory device such as a RAM or an instruction register and/or in a non-volatile memory device such as a flash memory or hard disk) and all actions described herein as performed by the software nodes, processes, or modules are performed by the processors 802 in conjunction with, as appropriate, the other elements in and/or connected to the computing device 800 (i.e., the network interface devices 806, display interfaces 808, user input adapters 810, and/or display device 812); (c) alternatively or additionally, to the extent it is described herein that the component processes and/or otherwise handles data, in some embodiments, such data is stored in the memory devices 804 (e.g., in some embodiments, in a volatile memory device such as a RAM and/or in a non-volatile memory device such as a flash memory or hard disk) and/or is processed/handled by the processors 802 in conjunction, as appropriate, the other elements in and/or connected to the computing device 800 (i.e., the network interface devices 806, display interfaces 808, user input adapters 810, and/or display device 812); (d) alternatively or additionally, in some embodiments, the memory devices 802 store instructions that, when executed by the processors 802, cause the processors 802 to perform, in conjunction with, as appropriate, the other elements in and/or connected to the computing device 800 (i.e., the memory devices 804, network interface devices 806, display interfaces 808, user input adapters 810, and/or display device 812), each or any combination of actions described herein as performed by the component and/or by any software nodes, processes, or modules described herein as included within the component.

The hardware configurations shown in FIG. 8 and described above are provided as examples, and the subject matter described herein may be utilized in conjunction with a variety of different hardware architectures and elements. For example: in many of the Figures in this document, individual functional/action blocks are shown; in various embodiments, the functions of those blocks may be implemented using (a) individual hardware circuits, (b) using an application specific integrated circuit (ASIC) specifically configured to perform the described functions/actions, (c) using one or more digital signal processors (DSPs) specifically configured to perform the described functions/actions, (d) using the server system described above with reference to FIG. 5, (e) using the hardware configuration described above with reference to FIG. 8, (f) via other hardware arrangements, architectures, and configurations, and/or via combinations of the technology described in (a) through (f).

### 11. Technical Advantages of Described Subject Matter

The following paragraphs describe technical advantages that may be realized in accordance with various embodiments described above. In contrast to traditional risk models that depend on historical behavior which renders them ineffective when the risk to be managed is unprecedented compared to historical data, the technology described and claimed in this application identifies extreme but plausible system response scenarios enables and directs preventive, strengthening, and/or protective system response measures. These preventive, strengthening, and/or protective system response measures prepare for and protect the system against unknown extreme events, thereby minimizing disruption of the system, loss of resources, and other adverse consequences of system instability. Another technical advantage is that the technology described and claimed in this application can provide an increased number of extreme but plausible system response scenarios which increases the probability of capturing unknown system vulnerabilities to a future unprecedented event, e.g., a crisis. In an example application to electronic market systems, this latter advantage increases a total Expected Uncollateralized Loss (EUL) with a higher number of stressed (extreme but plausible) scenarios used. The difference between margin requirements and worst-case EUL of an account may be used to determine additional margin (add-on) to be pledged as well as other risk management responses. Another technical advantage in an example application to electronic market systems is the technology described and claimed in this application accurately captures the tail distribution of the market assets being analyzed which represent the simulated extreme but plausible scenarios.

The technological improvements offered by the technology described in this document can also be applied in different domains in addition to those described above. For example, the technology described and claimed in this application may be applied in any domain or system that requires or may benefit from preventive, strengthening, preventive, and/or protective measures for unknown future extreme events.

### 12. Selected Terminology

Whenever it is described in this document that a given item is present in “some embodiments,” “various embodiments,” “certain embodiments,” “certain example embodiments, “some example embodiments,” “an exemplary embodiment,” or whenever any other similar language is used, it should be understood that the given item is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, element, component, attribute, etc. is present in at least one embodiment, though is not necessarily present in all embodiments. Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an” and “the” should be read as meaning “at least one,” “one or more,” or the like; the term “example” is used provide examples of the subject under discussion, not an exhaustive or limiting list thereof; the terms “comprise” and “include” (and other conjugations and other variations thereof) specify the presence of the associated listed items but do not preclude the presence or addition of one or more other items; and if an item is described as “optional,” such description should not be understood to indicate that other items are also not optional.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

### 13. Additional Applications of Described Subject Matter

While a particular detailed electronic market application is described herein, it should be understood that this application is just a non-limiting example. The technology described and claimed herein has many other applications.

Although process steps, algorithms or the like, including without limitation with reference to Figures described above, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

1. Apparatus including a generative neural network for generating extreme but plausible scenarios for a system with multiple data categories, the apparatus comprising:
one or more hardware processors;
one or more memories in communication with the one or more hardware processors; wherein:
the one or more hardware processors and the one or more memories are configured to:
determine evaluation change events for the multiple data categories for repeated time intervals over a time period to produce training data;
determine one or more training data sets based on the training data;
(i) generate noise data associated with multiple random variables;
(ii) process the noise data, by a first neural network of a Generative Adversarial Network (GAN), to produce generated input data;
(iii) process, by a second neural network of the GAN, the generated input data and the one or more training data sets to produce a loss value;
(iv) modify the first neural network and the second neural network based on the loss value;
repeat (i)-(iv) until the loss value reaches a convergence value resulting in a trained GAN including a trained first neural network;
generate evaluation change events for the multiple data categories using the trained first neural network, and based on the evaluation change events, produce generated change events;
filter the generated change events to identify extreme but plausible scenarios using a predetermined change measure with one or more predetermined thresholds; and
provide information concerning the extreme but plausible scenarios to a user interface.

2. The apparatus in claim 1, wherein the one or more hardware processors and the one or more memories are configured to generate at least one validation data set for hyperparameter training of the first neural network and the second neural network and at least one test data set for testing the trained first neural network.

3. The apparatus in claim 2, the one or more hardware processors and the one or more memories are configured to evaluate the trained first neural network using the at least one test data set to determine whether the trained first neural network is generating plausible events.

4. The apparatus in claim 1, wherein a dimension of the noise corresponds to one of a Student's t-probability distribution or a normal probability distribution.

5. The apparatus in claim 1, wherein the noise is multivariate noise for multiple data categories being monitored.

6. The apparatus in claim 1, wherein the predetermined change measure includes one of: Euclidean distance, absolute distance, Mahalanobis distance, cosine similarity, hamming distance, Minkowski distance, Jaccard index, and Haversine distance.

7. The apparatus in claim 1, wherein the second neural network of the GAN is a critic GAN network.

8. The apparatus in claim 1, wherein modifying the first neural network and the second neural network based on the difference includes updating weights and biases associated with the first neural network and the second neural network based on the loss value.

9. The apparatus in claim 1, wherein the convergence value corresponds to an equilibrium being reached between the first neural network and the second neural network.

10. The apparatus in claim 1, wherein the one or more hardware processors and the one or more memories are configured to perform operations including pre-processing the training data to produce pre-processed training data for the training data set.

11. A computer-implemented method for generating, using generative neural networks, extreme but plausible scenarios related to a system, the method comprising the following steps:
determining, by one or more computers, evaluation change events for multiple data categories included in the system for repeated time intervals over a time period to produce training data;
determining, by the one or more computers, one or more training data sets based on the training data;
(i) generating, by the one or more computers, noise data associated with multiple random variables;
(ii) processing the noise data, by a first neural network of a Generative Adversarial Network (GAN), to produce generated input data;
(iii) processing, by a second neural network of the GAN, the generated input data and one or more training data sets to produce a loss value;
(iv) modifying, by the one or more computers, the first neural network and the second neural network based on the loss value;
repeat (i)-(iv) until the loss value reaches a convergence value resulting in a trained GAN including a trained first neural network;
the trained first neural network generating evaluation change events for the multiple data categories, and based on the evaluation change events, producing generated change events;
filtering, by the one or more computers, the generated events to identify extreme but plausible scenarios using a predetermined change measure with one or more predetermined thresholds; and
providing, by the one or more computers, information concerning the extreme but plausible scenarios to a user interface.

12. The method in claim 11, wherein the (iv) modifying step includes updating parameters associated with the first neural network and the second neural network of the GAN based on the loss value.

13. The method in claim 11, wherein the convergence value corresponds to an equilibrium being reached between the first neural network and the second neural network of the GAN.

14. The method in claim 11, further comprising generating at least one validation data set for hyperparameter training of the first neural network and the second neural network of the GAN and at least one test data set for testing the trained first neural network of the GAN.

15. The method in claim 14, further comprising evaluating the trained first neural network of the GAN using the at least one test data set to determine whether the trained first neural network of the GAN is generating plausible events.

16. The method in claim 11, wherein the predetermined change measure includes one of: Euclidean distance, absolute distance, Mahalanobis distance, cosine similarity, hamming distance, Minkowski distance, Jaccard index, and Haversine distance.

17. A non-transitory, computer-readable storage medium storing instructions for use with a computer system, the computer system including at least one hardware processor, the stored instructions comprising instructions configured to cause the at least one hardware processor to perform operations comprising:
determining evaluation change events for multiple data categories included in a system for repeated time intervals over a time period to produce training data;
determining one or more training data sets based on the training data;
(i) generating noise data associated with multiple random variables;
(ii) processing the noise data at a first neural network of a Generative Adversarial Network (GAN) to produce generated input data;
(iii) processing, by a second neural network of the GAN, the generated input data and one or more training data sets to produce a loss value;
(iv) modifying the first neural network and the second neural network based on the loss value;
repeat (i)-(iv) until the loss value reaches a convergence value resulting in a trained GAN including a trained first neural network;
the trained first neural network generating evaluation change events for the multiple data categories, and based on the evaluation change events, producing generated change events;
filtering the generated change events to identify extreme but plausible scenarios using a predetermined change measure with one or more predetermined thresholds; and
providing information concerning the extreme but plausible scenarios to a user interface.

18. The non-transitory, computer-readable storage medium in claim 17, wherein the (iv) modifying includes updating parameters associated with the first neural network and the second neural network of the GAN based on the loss value.

19. The non-transitory, computer-readable storage medium in claim 17, wherein the convergence value corresponds to an equilibrium being reached between the first neural network and the second neural network of the GAN.

20. The non-transitory, computer-readable storage medium in claim 17, wherein the predetermined change measure includes one of: Euclidean distance, absolute distance, Mahalanobis distance, cosine similarity, hamming distance, Minkowski distance, Jaccard index, and Haversine distance.
